(19) United States
(12) Patent Application Publication
(10) Pub. No.: US 2007/0024099 A1
(43) Pub. Date: Feb. 1, 2007

(54) Device for fixing a first part of a motor vehicle seat relative to a second part

(76) Inventors: Burckhard Becker, Solingen (DE); Wilfried Beneker, Leichlingen (DE)

Correspondence Address: MCCARTER & ENGLISH LLP;CITYPLACE I, 185 ASYLUM STREET, HARTFORD, CT, 06103, US

(21) Appl. No.: 10/571,229

(22) PCT Filed: Sep. 3, 2004
(86) PCT No.: PCT/DE04/01971

§ 371 Date: Mar. 6, 2006

(30) Foreign Application Priority Data
Sep. 6, 2003 (DE) 103 41 498.3

(51) Int. Cl. B60N 2/02

(52) U.S. Cl. 297/366

(57) ABSTRACT

The invention relates to a device for fixing a first part (22) of a motor vehicle seat which is adjustable relative to a second part (28), relative to said second part (28), comprising a) an outer piece (20), connected to the first part (22) of the seat, having a toothing (24), b) an inner piece (26), connected to the second part (28), having a toothing (30) engaged in an engaging region (34) with the toothing (24) of the outer piece (20), whereby outer piece (20) and inner piece (26) together form two clamping gaps (38, 40), each of which tapers in countersense, c) two clamping pieces (42, 44), of which one clamping piece (42) is arranged in one of the clamping gaps (38, 40) and d) an elastic means, pre-tensioning each clamping piece (42, 44) in the corresponding clamping gap (38, 40) in a clamped position.

The invention relates to a locking device by means of which a first part of a motor vehicle seat is adjustable with respect to a second part of this motor vehicle seat, with for example the first part being a seat back and the second part being realized by a seat part of the vehicle seat. In such type adjusting devices, the objective is to obtain a device with zero clearance in the locked state, meaning that the first part is fixed with a zero clearance fit with respect to the second part. For example, when adjusting the recline of the seat back, a slight play in the seat back hinge is perceivable at the top edge of the seat back because the seat back constitutes quite long a lever arm. It is therefore an objective to indicate a locking device for the seat back for example that provides, as far as practicable, a zero clearance fit, meaning that, in the locked state, it connects the seat back to the seat part so as to provide a zero clearance fit. During adjustment there may be a clearance as long as, in the locked state, it is as small as possible or even disappears completely.

According to prior art, seat backs are pivotally carried on the seat part. This pivotal mounting normally has a bearing clearance. Attempts have already been made to minimize this bearing clearance, see DE 197 31 305 C2 for example.

This is where the invention comes into play. It is directed to modifying and improving a device of the type mentioned herein above so as to provide a zero clearance fixation of the first part with respect to the second part in the locked state. It is an additional object of the invention to indicate a device of the type mentioned herein above in which the forces and couples occurring in the locked state of the device during normal driving operation of the motor vehicle are absorbed by the device in the most favorable manner.

This object is solved by a device for locking a first part of a motor vehicle seat adjustable relative to a second part, with respect to said second part, more specifically by a device for locking a seat back with respect to a seat part, said device having a) an outer part which is connected to the first part of the seat and comprises a toothed portion, b) an inner part which is connected to the second part and comprises a toothed portion engaging with the toothed portion of the outer part in an engagement region, outer part and inner part forming together two inversely arranged, tapering clamping gaps, with c) two clamping parts, one of said clamping parts being disposed in a respective one of the two clamping gaps, d) an elastic means that biases a respective one of the clamping parts in a clamping position in the associated clamping gap, the toothed portion of the inner part being pushed into the toothed portion of the outer part when the two clamping parts are in the clamping position and the inner part being in a zero clearance fit relationship with the outer part, and e) a release part which normally is in a neutral position and which, from this neutral position, is movable into two different directions, said release part causing the one clamping part to move out of its clamping position in the one direction and causing the other clamping part to move out of its clamping position in the other direction.

This device offers the great advantage that the first part needs not be carried relative to the second part. Accordingly, any bearing clearance of such a mounting is eliminated.

The invention proposes to relatively support the first part with respect to the second part in three regions. One of these three regions is the shape-mating engagement of the two toothed portions. The other two regions are formed by the clamping regions. These permit to eliminate any clearance. Each clamping part is pushed into the clamping gap far enough for a zero clearance fit to occur. This means that in different positions of the two parts relative to each other, the clamping parts may assume different relative positions. In the released state of the device, meaning when the release part is actuated, a certain amount of clearance occurs between the two parts of the motor vehicle seat; said clearance makes adjustment possible and may be kept small in terms of construction. This clearance however disappears as soon as the release part comes free. Then, the elastic means brings the device back into the locked state. In same, the clamping parts are in their clamping position.

According to prior art, in contrast, the first part is also supported with respect to the second part by a bearing shaft. The supporting path is thereby smaller than in the invention. It typically is approximately half the diameter of the toothed portion whilst in the invention it is approximately equal thereto. Accordingly, the invention makes it possible to better utilize the material or allows for smaller construction.

The one of the two clamping parts is responsible for clamping in the one direction of adjustment, the other one for clamping in the other direction of adjustment. Such type constructions are known in principle, for example from U.S. Pat. No. 5,590,931 and U.S. Pat. No. 6,488,134 B2.

If the release part is moved from its neutral position into the one actuated position, meaning in one of the two directions of rotation, and is retained in said position, the associated clamping part is free from the clamping position and the first part can be adjusted with respect to the second part in the direction that has come free. Adjustment in the other direction is not possible. Adjustment in the enabled direction is possible as long as the associated clamping part is not in the clamping position. Both slow and fast adjustment can be performed according to any desire the user may have. At the end of the adjusting movement, when the desired relative position of the two parts with respect to each other has been attained, the release part is released and the parts are locked by clamping.

The interaction of the toothed portions of inner and outer part permits to clearly position these two parts with respect to each other. The two clamping arrangements provide the device with a zero clearance fit. Accordingly, the device operates both by providing a shape-mating fit and by clamping.

In an improvement, there is proposed that the toothed portion of the inner part comprises at least one tooth and that the toothed portion of the outer part comprises at least one tooth gap or, in reverse, the toothed portion of the inner part at least one tooth gap and the toothed portion of the outer part at least one tooth. It is preferred that the tooth gaps have more than one tooth or more than one tooth gap respectively. If only one tooth is provided, it always remains engaged with the tooth gap with the tooth pivoting within said tooth gap.

The at least one tooth may have any shape; it may correspond to the usual tooth shape, but may also have the shape of a head and be omega-shaped for example. The same applies to the tooth gap. For the shape, it only matters that the tooth is precisely supported with zero clearance in its gap and that at least a pivot motion of the tooth relative to the gap is possible. Zero clearance fit of the tooth supported in the gap is achieved by the clamping action of the two clamping regions.

In another improvement it is proposed that the engagement region and the two clamping parts are disposed on the vertexes of a triangle, preferably of an isosceles triangle. This triangle is referred to as a supporting triangle. Zero clearance fit between the first part and the second part is only given when the device is in the locked state. Preferably, the device has a mirror-symmetrical structure with the mirror plane passing through the engagement region and on the center between the two clamping parts. In this case, the supporting triangle also is an isosceles triangle.

In another improvement it is proposed that the toothed portion of the inner part and/or the toothed portion of the outer part extend over 360°. In principle, the device can be implemented for circumferential adjustment or only for adjustment within a certain pivot range. Each toothed portion is advantageously formed so as to just achieve the desired angle of adjustment. Beyond this angle, no toothed portion is needed so that there is no need of forming such there.

Preferably, the clamping parts are either circular such as disks, or wedge-shaped, with a truncated wedge shape being particularly appropriate. Rolls as they are usually utilized in rolling-contact bearings may for example be utilized as the clamping parts. Preferably, the two clamping parts of the device are built according to the same principle.

In a preferred developed implementation, it is proposed that the clamping gaps are located in the same plane as the toothed portion of the inner part and the toothed portion of the outer part. In this case, the supporting triangle lies in a plane that coincides with the main planes of the component parts used. However, it is also possible and advantageous to arrange the clamping gaps in another plane than the plane in which the toothed portion of the inner part and the toothed portion of the outer part lie. This construction is particularly suited for circumferential devices, meaning in which the toothed portions extend over 360°. It is preferred that the offset between the planes be small.

In a preferred embodiment, the outer part has an opening in which there is located the inner part. It is preferred that the outer part has an internal toothed portion and that the inner part has an external toothed portion.

The toothed portions always mesh even while the locking device of the invention is being adjusted. Accordingly, the device can be locked in any position.

Other features and advantages of the invention will become more apparent upon reviewing the appended claims and the following non restrictive description of embodiments of the invention, given by way of example only with reference to the drawing. In said drawing:

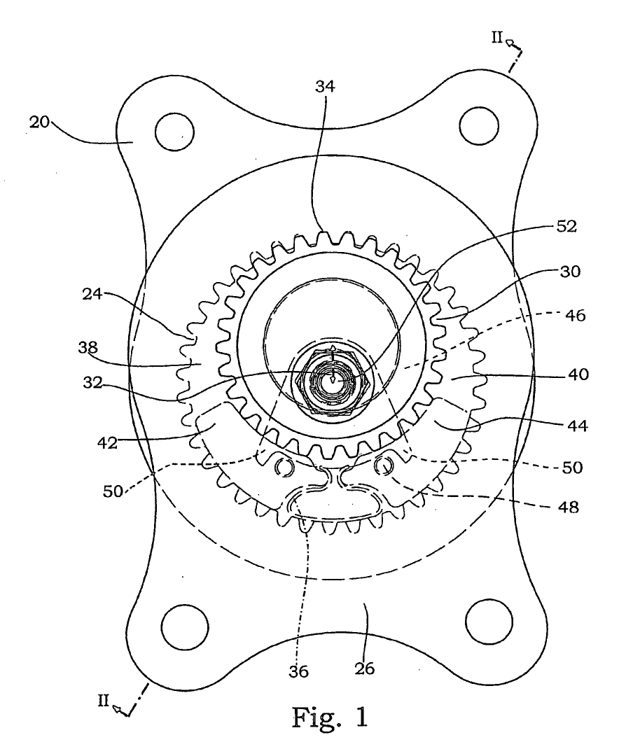

FIG. 1 is a top view of a circumferential device,

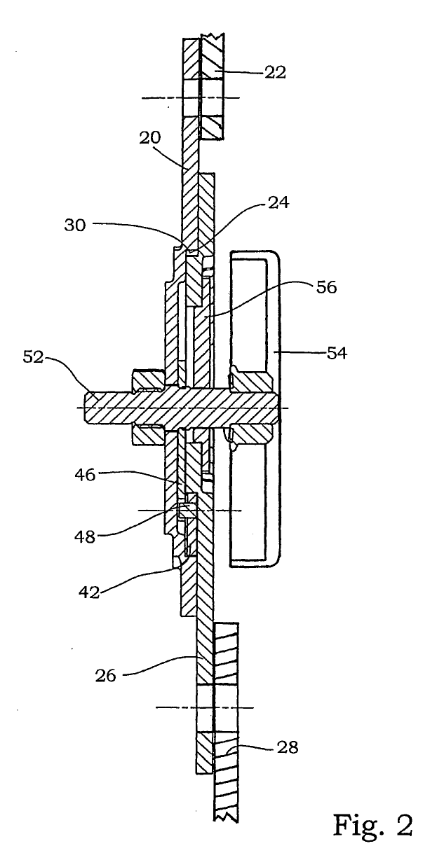

FIG. 2: is a sectional view taken along the section line II-II in FIG. 1 and with additional parts,

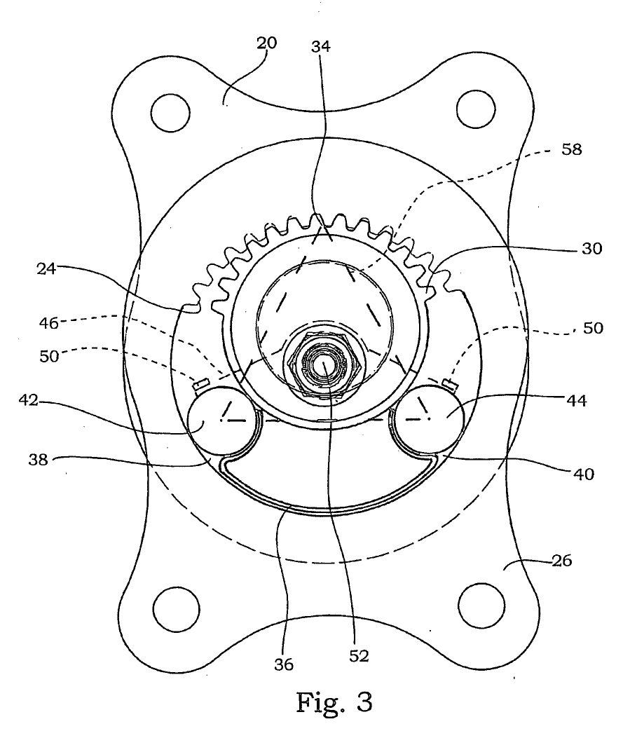

FIG. 3: is a view like FIG. 1, but for an exemplary embodiment having a limited pivot angle,

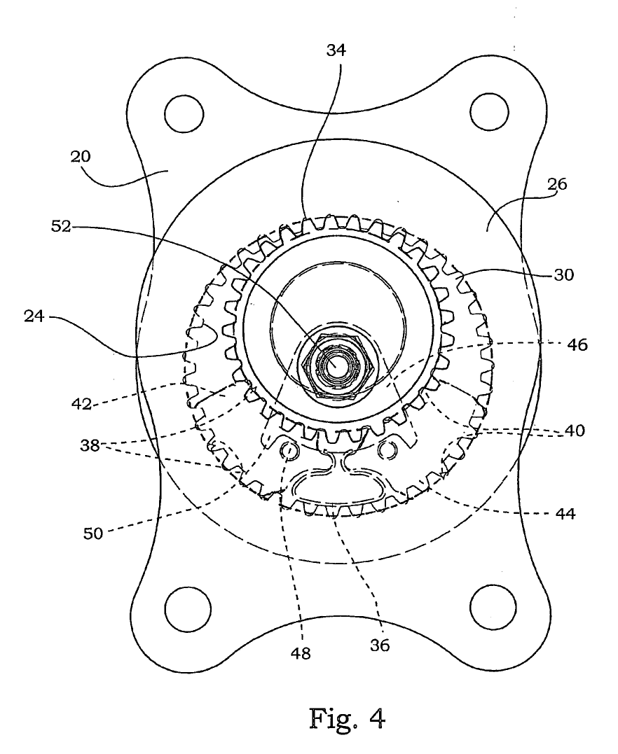

FIG. 4: is an illustration like FIG. 1 of a third exemplary embodiment in which the clamping gap is located in another plane than the toothed portions,

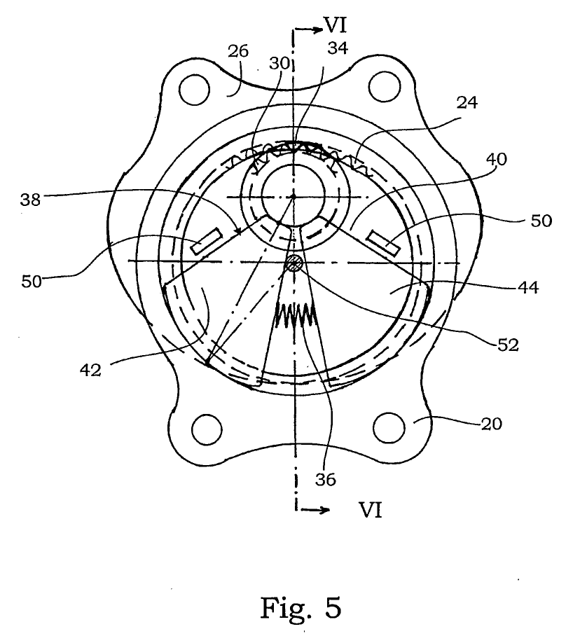

FIG. 5: is an illustration like FIG. 1 of a fourth exemplary embodiment, said embodiment being circumferential and exhibiting different diameters of the toothed circular surfaces and

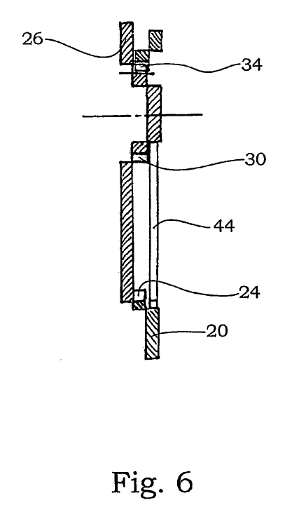

FIG. 6: is a sectional view taken along section line VI-VI in FIG. 5.

Herein after, the first exemplary embodiment shown in the FIGS. 1 and 2 will be described first, with the other exemplary embodiments being described next, in particular with regard to the features by which they differ from the first exemplary embodiment.

The FIGS. show an outer part 20 that is solidly connected to a first part 22, here for example a carrier of a seat back. This outer part comprises a toothed portion 24 that is internally toothed. There is further shown an inner part 26, which is connected to a second part 28 (see FIG. 2), for example a seat carrier of a vehicle seat. This inner part 26 has a toothed portion 30 that is externally toothed. Both toothed portions 24, 26 are circumferential, meaning they extend over 360° each. The internally toothed portion 24 receives the toothed portion of the inner part 26. The diameter of the externally toothed portion 30 is about 80% of the diameter of the internally toothed portion 24. The toothed portions 24, 30 form gear wheels that are eccentric with respect to one another. The eccentric amount 3 is illustrated by the double-headed arrow 32 in FIG. 1, with the arrow heads being located in the center of the respective one of the toothed portions 24, 30. The toothed portions 24, 30 mesh in an engagement region 34. Diametrically opposite thereto, there is an elastic means 36, more specifically a spring. It is located where the distance between the two toothed portions 24, 30 is greatest. On either side of the elastic means 36, clamping gaps 38, 40 are formed in which the spacings between the tooth tips of the toothed portions taper toward the engagement region 34. They taper in opposite directions with the left clamping gap 38 of FIG. 1 tapering clockwise and the right clamping gap 40, counter-clockwise. Clamping parts are located on either side of the elastic means 36 and are biased by same, namely a left clamping part 42 in the left clamping gap 38 and a right clamping part 44 in the right clamping gap 40. The clamping parts 42, 44 are identically built but are arranged in a mirror-inverted fashion. The mirror plane passes through the centers of the two toothed portions 24, 30, meaning it is imposed by the double-headed arrow 32 and is oriented at right angles with respect to the plane of the illustration of FIG. 1. The clamping parts 42, 44 are crescent-shaped, truncated wedges, each fitting against the tooth tips of the toothed portions. In the state shown in FIG. 1, the device is in the clamping position, with the clamping parts 42, 44 fitting firmly against the tooth tips. As a result, the outer part 20 is solidly connected to the inner part 26. The elastic means 36 urges the clamping parts 42, 44 far enough into the clamping gap 38, 40 to provide zero clearance in the engagement region 34.

A release part 46 is provided. It cooperates with projections 48 projecting each from either clamping part 42, 44 into the plane in which there is located the release part 46. The release part 46 has driver members 50 capable of striking the projections 48 from the outside. Normally, in the locked or stopped position, the driver members 50 are spaced from the projections 48.

The release part 46 is connected to an axle 52 and is pivoted by rotating said axle 52. In the counter-clockwise direction, the left driver member 50 causes the release part 46 to strike against the projection 48 of the left clamping part 42 and pulls same into a free position, meaning out of the clamping position. Now, the outer part 20 is allowed to rotate with respect to the inner part 26. This preferably occurs by an external force, e.g., through a separate drive or a passenger.

If the release part 46 is rotated clockwise, it is the right clamping part 44 that comes free so that adjustment between the parts 20, 26 may now occur in the other direction of rotation.

As best shown in FIG. 2, the two parts 20, 26 are preferably stamped component parts made from a flat material. The toothed portions 24, 30 are made by staggered arrangement in the starting flat material. The clamping parts 42, 44 are located between these two parts 20, 26.

FIG. 2 shows some component parts that are not illustrated in FIG. 1. These are the already mentioned first part 22, the already mentioned second part 28, a handle 54 and a cover 56. The handle serves to actuate the axle 52 and, as a result thereof, the release part 46. The cover 56 closes the inner part 26 toward the handle 54 and also effects certain positioning of the inner part 26 with respect to the axle 52. This positioning however is not determining; the position of the inner part 26 with respect to the outer part 20 is solely achieved by the cooperation between the engagement region 34 and the two clamping regions. The left clamping region is thereby formed by the left clamping gap 38 and the left clamping part 42, with the right clamping region being accordingly formed by the right clamping gap 40 and the right clamping part 44.

If adjustment occurs starting from the relative position between outer part 20 and inner part 26 shown in the FIGS. 1 and 2, the inner part 26 wobbles in the outer part 20. As a result, the first part 20 not only performs a pivot motion with respect to the second part 28, but also a movement in the radial plane of the axle 52. This superimposed movement can be used to advantage. For example, in the preferred implementation as a locking device for a seat back as it is described herein, the center of the inner part can be allowed rising so much that in the forward tilted position of the seat back the state is as shown in FIG. 1. Then, the fastening holes of outer part 20 and inner part 26 are spaced the greatest possible distance apart or the double-headed arrow 32 is vertical. If, from there, the seat back is positioned into the position of utilization, the center of the inner part 26 moves down- and backward. Then, the double-headed arrow 32 is oriented approximately horizontally.

Now, the second exemplary embodiment shown in FIG. 3 will be described herein after. In contrast to the first exemplary embodiment, this locking device is not circumferential but permits pivot motion over a given angular range. Accordingly, the toothed portion is only formed over an angular range of approximately 120° for example. The remaining portion has a smooth surface feature. Unlike in the first exemplary embodiment in which the clamping gap 38, 40 is formed by flattened tooth tips of the toothed portions 24, 30, the clamping gap 38, 40 in the second exemplary embodiment is bounded by smooth surfaces extending on a cylindrical surface area.

Unlike in the first exemplary embodiment, the clamping parts 42, 44 are now rolls or circular disks. Friction of the device is reduced as a result thereof Again, the clamping parts 42, 44 are urged into their clamping position by a common spring. The release part 46 has two drive members 50 capable of acting from the outside on the clamping parts 42, 44. In the fixed position shown, there is an air gap between them and the clamping parts 42, 44.

Now, the third exemplary embodiment shown in FIG. 4 will be described herein after. While in the first and in the second exemplary embodiment the clamping gaps 38, 40 are in the same plane as the toothed portions 24, 30, this is no longer the case in the third exemplary embodiment. The toothed portions 24, 30 are located in a plane that is offset approximately one tooth thickness with respect to the plane underneath in which the clamping gaps 38, 40 are located. Unlike in the first exemplary embodiment, this provision makes it possible to realize the clamping gap 38, 40 by smooth surfaces.

The fourth exemplary embodiment shown in the FIGS. 5 and 6 shows quite a great difference between the two toothed portions 24, 30. Now, the externally toothed portion 30 has an outer diameter that is about 40% the diameter of the internally toothed portion 24. It is smaller than half the clear inner diameter of the internally toothed portion 24. As a result, the axle 52 is external to the externally toothed portion 30. Put another way, the externally toothed portion 30 is located between axle 52 and internally toothed portion 24. As best shown in FIG. 6, the plane in which the toothed portions 24, 30 lie is offset with respect to the plane in which there are located the clamping parts 42, 44. The offset is approximately the tooth thickness visible in FIG. 6 or the material thickness of the flat material used. Thanks to the offset, the diameters of the arcs bounding the clamping gaps 38, 40 can be chosen independent of the diameter of the toothed portions. However, the following requirement should be met: the spacing between the two clamping points of a clamping part and the walls of the clamping gap plus the diameter on which lies the inner limit of the clamping gap should approximately correspond to the diameter of the internally toothed portion 24 and by no means strongly differ therefrom. Differences in the range of plus/minus 30%, more specifically 20% seem possible. The spacing between the two clamping points of a clamping part and the walls of the clamping gap can be seen from FIG. 5 for the left clamping part and is shown by a dash-dotted line joining the two marked clamping points. In FIG. 5, the inner limit of the clamping gap lies on a circle that is slightly smaller than the diameter of the externally toothed portion 30.

In FIG. 3, a supporting triangle 58 is shown by a dashed line. In the concrete exemplary embodiment, this triangle is an isosceles triangle; in this concrete case even an equilateral triangle.

1. A device for locking a first part of a motor vehicle seat adjustable relative to a second part, with respect to said second part, more specifically a device for locking a seat back with respect to a seat part, said device comprising:
an outer part which is connected to said first part of the seat and comprises a toothed portion;
an inner part which is connected to said second part and comprises a toothed portion engaging with said toothed portion of said outer part in an engagement region, said outer part and said inner part forming together two inversely arranged, tapering clamping gaps;
two clamping parts, one of said clamping parts being disposed in one of said two clamping gaps;
an elastic means that biases a respective one of said clamping parts in a clamping position in the associated clamping gap, said toothed portion of said inner part being pushed into said toothed portion of said outer part when said two clamping parts are in the clamping position and said inner part being in a zero clearance fit relationship with said outer part; and
a release part which normally is in a neutral position and which, from this neutral position, is movable into two different directions, said release part causing said one clamping part to move out of its clamping position in the one direction and causing said other clamping part to move out of its clamping position in the other direction.

2. The device as set forth in claim 1, wherein the toothed portion of the inner part comprises at least one tooth and the toothed portion of the outer part comprises at least one tooth gap or, in reverse, that the toothed portion of the inner part comprises at least one tooth gap and the toothed portion of the outer part, at least one tooth.

3. The device as set forth in claim 1, wherein the engagement region and the two clamping parts are disposed on the vertexes of a supporting triangle, preferably of an isosceles triangle.

4. The device as set forth in claim 1, wherein the toothed portion of the inner part is located on an arc, more specifically on an arc of a circle, and that the toothed portion of the outer part is located either on an arc, more specifically on an arc of a circle, or on a straight line.

5. The device as set forth in claim 1, wherein the toothed portion of the inner part and/or the toothed portion of the outer part extend over 360°.

6. The device as set forth in claim 1, wherein the clamping parts are circular or wedge-shaped, and more specifically are in the shape of a truncated wedge.

7. The device as set forth in claim 1, wherein the clamping gaps are located in the same plane as the toothed portion of the inner part and the toothed portion of the outer part or that the clamping gaps are located in a plane that is offset with respect to the plane in which there are disposed the toothed portion of the inner part and the toothed portion of the outer part, more specifically that it is offset by about one tooth thickness of the toothed portion.

8. The device as set forth in claim 1, wherein the outer part comprises an opening in which there is located the inner part.

9. The device as set forth in claim 1, wherein, when the release part has been moved out of its neutral position, there is a clearance between the clamping part moved out of its clamping position and its clamping gap and that this clearance is significantly smaller than the tooth height of a least one toothed portion, more specifically at least ten times smaller than the tooth height of at least one toothed portion.

10. The device as set forth in claim 1, wherein, when the release part has been moved out of its neutral position, there occurs between the clamping part moved out of its clamping position and its clamping gap the smallest possible clearance, just sufficient to allow release of the device.

11. The device as set forth in claim 1, wherein, in the neutral position of the release part, the inner part is solely fixed relative to the outer part by a combination of shape-mating engagement in the engagement region and clamping by the two clamping parts in their clamping position.
